(19) United States
(12) Patent Application Publication
(10) Pub. No.: US 2025/0244757 A1
(43) Pub. Date: Jul. 31, 2025

(54) MANUFACTURING SYSTEM FOR ELECTRONIC DEVICE

(71) Applicant: InnoLux Corporation, Miao-Li County (TW)

(72) Inventors: Tzu-Yun LIN, Miao-Li County (TW); Jhih-Ren CAI, Miao-Li County (TW); Yu-Ting CHANG, Miao-Li County (TW); Wen-Jie TSAI, Miao-Li County (TW)

(21) Appl. No.: 19/003,058

(22) Filed: Dec. 27, 2024

(30) Foreign Application Priority Data
Jan. 25, 2024 (CN) 202410107925.X

(51) Int. Cl. G05B 23/02

(52) U.S. Cl. CPC G05B 23/0254

(57) ABSTRACT

A manufacturing system includes: a manufacturing apparatus and a monitoring system. The manufacturing apparatus is used to provide a data set. The monitoring system is used to receive the data set to calculate at least a feature value, so as to define a data set model. The manufacturing apparatus receives the data set model for monitoring a manufacturing process.

### CROSS-REFERENCE TO RELATED APPLICATIONS

This application claims the benefits of the Chinese Patent Application Serial Number 202410107925.X, filed on Jan. 25, 2024, the subject matter of which is incorporated herein by reference.

### BACKGROUND

### Field of the Disclosure

The present disclosure relates to a manufacturing system and, more specifically, to a manufacturing system for an electronic device.

### Description of Related Art

As the workload of the manufacturing apparatus increases, the management requirements of the manufacturing apparatus are also increasing, and thus the demand for various automated monitoring is gradually increasing. For example, the process parameters (such as temperature, pressure, etc.) of the manufacturing apparatus need to be automatically detected or managed.

However, the data set (such as data distribution) of these process parameters often exhibits asymmetric normal distribution. The data of these process parameters is not suitable for processing using the statistical method of traditional normality assumption. For example, the data is difficult to set the control boundaries for normal and abnormal states. When the control boundaries are set too strictly, it will lead to too many misjudged abnormal states. When the control boundaries are set too loosely, there is a risk of missing abnormal states. Therefore, for data sets of various data types, special corresponding processing methods (such as corresponding control boundaries) have to be used. Currently, the data type of the data set can only be determined by professionals. However, manpower can no longer handle the huge amount of data. Therefore, how to automatically distinguish the data type of the data set is a current issue that needs to be solved.

Therefore, it is desired to provide an improved manufacturing system to alleviate and/or obviate the above problems.

### SUMMARY

The present disclosure provides a manufacturing system for an electronic device, which includes: a manufacturing apparatus and a monitoring system. The manufacturing apparatus provides a data set. The monitoring system receives the data set and calculates a feature value to define a data set model. The manufacturing apparatus receives the data set model to monitor a manufacturing process.

Other novel features of the disclosure will become more apparent from the following detailed description when taken in conjunction with the accompanying drawings.

### BRIEF DESCRIPTION OF DRAWINGS

FIG. 1 shows a flowchart illustrating the steps of a management method of a manufacturing system according to an embodiment of the present disclosure;

FIG. 2 shows a system architecture diagram of the manufacturing system according to an embodiment of the present disclosure;

FIG. 3A shows a schematic diagram of the data type of the data set according to an embodiment of the present disclosure;

FIG. 3B shows a schematic diagram of the data type of the data set according to another embodiment of the present disclosure;

FIG. 4A shows a schematic diagram of the data set corresponding to the detection procedure of the data value change point in the first aspect of the present disclosure;

FIG. 4B shows a flowchart illustrating the steps of the detection procedure of the data value change point in the first aspect according to an embodiment of the present disclosure;

FIG. 4C shows a flowchart illustrating the steps of the detection procedure of the data value change point in the first aspect according to another embodiment of the present disclosure;

FIG. 5A shows a schematic diagram of the data set corresponding to the detection procedure of the data value change point in the second aspect of the present disclosure;

FIG. 5B shows a flowchart illustrating the steps of the detection procedure of the data value change point in the second aspect according to an embodiment of the present disclosure;

FIG. 5C shows a flowchart illustrating the steps of the detection procedure of the data value change point in the second aspect according to another embodiment of the present disclosure;

FIG. 6 shows a flowchart schematically illustrating the training process of the data type classification unit according to an embodiment of the present disclosure; and

FIG. 7 shows a flowchart schematically illustrating the actual operation of the change point detection unit, the data set segmentation unit, the feature value calculation unit and the data type classification unit according to an embodiment of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims, such as “electrically connect” and “couple”, are intended that an element may not only directly electrically connect to other element, but also indirectly electrically connect to other element.

In this disclosure, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “range is a first value to a second value” and “range is between a first value and a second value” mean that the range includes the first value, the second value and other values between the first value and the second value.

Unless otherwise defined, all terms (including technical and scientific terms) used here have the same meanings as commonly understood by those skilled in the art of the present disclosure. It is understandable that these terms, such as those defined in commonly used dictionaries, should be interpreted as having a meaning consistent with the relevant technology and the background or context of the present disclosure, rather than in an idealized or excessively formal interpretation.

The management method of the manufacturing system of the present disclosure may be used to manage a manufacturing system that manufactures electronic devices and/or electronic components. The electronic device may include a display device, an imaging device, an assembly device, a backlight device, an antenna device, a tiled device, a touch display, a curved display or a free shape display, but it is not limited thereto. The electronic device may further include electronic components. The electronic component may include a passive component and an active component, such as a capacitor, a resistor, an inductor, a diode, a transistor, etc. The diode may include a light emitting diode or a photodiode. The light emitting diode may include, for example, an organic light emitting diode (OLED), a sub-millimeter light emitting diode (mini LED), a micro light emitting diode (micro LED) or a quantum dot light emitting diode (quantum dot LED), but it is not limited thereto.

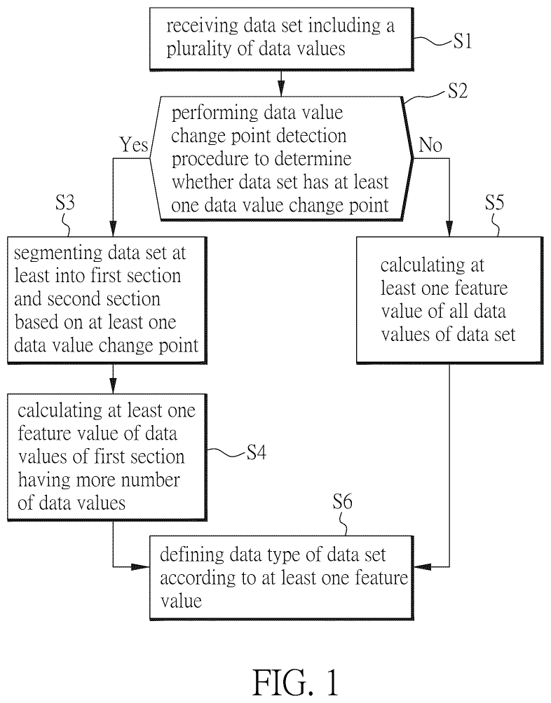

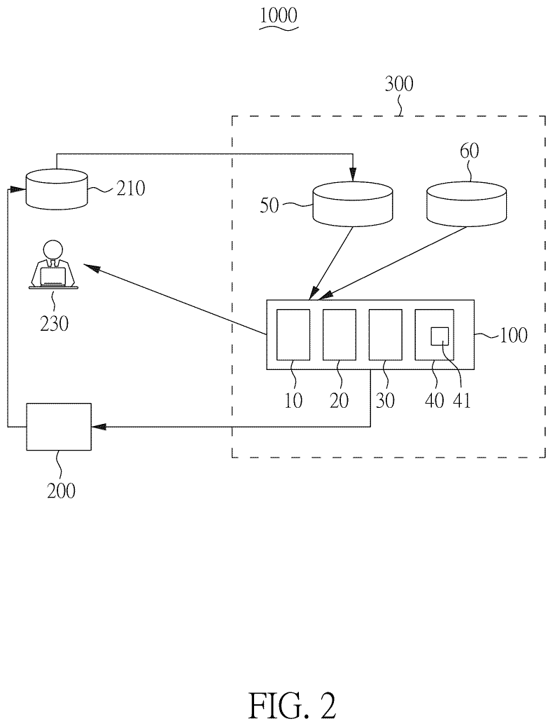

FIG. 1 is a flowchart illustrating the steps of a management method of a manufacturing system of an electronic device according to an embodiment of the present disclosure. The management method of the manufacturing system can be executed by a detection unit 100 (shown in FIG. 2). First, step S1 is executed, in which a data set is received, where the data set includes a plurality of data values such as a process parameter at different time points when a manufacturing apparatus (such as a machine) manufactures electronic devices, which may be, for example, process temperature, the flow rate and pressure of the introduced gas, the concentration and pH value of the introduced fluid, etc., but it is not limited thereto. Then, step S2 is executed, in which a data value change point detection procedure is performed to determine whether the data set has at least one data value change point. When the data set has at least one data value change point, step S3 is executed, in which the data set is segmented at least into a first section and a second section based on at least one data value change point. Then, step S4 is executed, in which at least one feature value of the data values of the first section is calculated, where the first section has a first number of data values, the second section has a second number of data values, and the first number is greater than the second number, that is, the first section has a larger number of data values. When the data set does not have a data value change point, step S5 is executed, in which at least one feature value of all data values of the data set is calculated. Then, step S6 is executed, in which the data type of the data set is defined according to at least one feature value.

In one embodiment, the management method of the manufacturing system can be used to detect and determine the data type of the data set so as to facilitate subsequent monitoring of the manufacturing procedures and/or process parameters of the manufacturing apparatus. In one embodiment, the data set can be regarded as a collection of data values within a period of time, such as a collection of process parameters of the manufacturing apparatus during a period of operation, but it is not limited thereto. The data sets can be defined into different data types according to their data distribution, and various data types can be regarded as various data set models. In addition, in one embodiment, the data set may be provided with a plurality of data value change points, so that the data set may be segmented into more than two sections. In this case, the detection unit 100 will find a section having the maximum number of data values in the sections, calculate at least one feature value of the section, and use the at least one feature value of the section to define the data type of the data set (that is, the data set model).

FIG. 2 is a system architecture diagram of a manufacturing system 1000 according to an embodiment of the present disclosure, and please refer to FIG. 1 at the same time. As shown in FIG. 2, the manufacturing system 1000 may include, for example, a manufacturing apparatus 200 and a monitoring system 300. The monitoring system 300 may include a detection unit 100. The detection unit 100 may include, for example, a change point detection unit 10 and a data set segmentation unit 20, a feature value calculation unit 30 and a data type classification unit 40. The monitoring system 300 may obtain the data set from the manufacturing apparatus 200 through various suitable signal transmission interfaces in wired transmission or wireless transmission manner (for example, step S1) for being provided to the detection unit 100 for calculation and/or analysis. For example, the manufacturing apparatus 200 may transmit the process parameters during the operation of the manufacturing process to a manufacturing end storage device 210, and the manufacturing end storage device 210 may perform communication with a monitoring end storage device 50 of the monitoring system 300, so as to transmit the process parameters to the monitoring end storage device 50, but it is not limited thereto. The change point detection unit 10 may perform a data value change point detection process to detect whether the data set has a data value change point (for example, step S2). The data set segmentation unit 20 may segment the data set into a plurality of sections according to the data value change point (for example, step S3). The feature value calculation unit 30 may select one of the segmented sections and calculate the feature value of the section (for example, step S4), or the feature value calculation unit 30 may calculate the feature value of the entire data set when the data set does not have a data value change point (for example, step S5). The data type classification unit 40 may be used to define the data type of the data set by comparing the feature value with the feature value of the model (for example, step S6, i.e., data set model). For example, the monitoring system 300 may include a data set model database 60, and the data set model database 60 store data of a plurality of data set models for allowing the detection unit 100 to perform comparison to define the type of data set model of the data set provided by the manufacturing apparatus 200. Then, the detection unit 100 may transmit the data type of the data set (that is, the data set model) to the manufacturing apparatus 200 through the monitoring system 300, and the manufacturing apparatus 200 may perform corresponding processing according to the data set model, for example, use a monitoring method that matches a specific data set model to monitor the manufacturing process performed by the manufacturing apparatus 200. In addition, the detection unit 100 may also transmit the data type of the data set to the user end 230, for example, to a display device or to a communication device of the user end 230, but it is not limited thereto.

In one embodiment, the data type classification unit 40 may include a machine learning model 41 and, after training, the machine learning model 41 may be provided with the ability to define the data type of the data set. For example, after training, the machine learning model 41 may generate an analysis result according to the feature value, and the analysis result may be compared with the data set model in the data set model database 60 so as to find the closest data set model, but it is not limited thereto. In more detail, the machine learning model 41 may be provided with a “training stage” and an “actual operation stage” after completing the training. In addition, the operation results of the machine learning model 41 in the “actual operation stage” may also be fed back to the machine learning model 41 itself, so as to continuously improve the capability of the machine learning model 41. In one embodiment, the type of the machine learning model 41 may include a convolutional neural network (CNN), a deep neural network (DNN), a recurrent neural network (RNN), a random forest, a decision tree, models with similar functions, etc., while it is not limited thereto. In one embodiment, the machine learning model 41 in the training stage may be trained through a large amount of training data, where the number of training data may be, for example, at least 150, but it is not limited thereto.

In one embodiment, the detection unit 100 may be, for example, a physical device equipped with a processor, or may be the processor itself, or may also be a computer program product executed by the processor, while the present disclosure is not limited thereto. In one embodiment, the change point detection unit 10, the data set segmentation unit 20, the feature value calculation unit 30 and the data type classification unit 40 may be, for example, functional modules that may be implemented by a processor executing instructions of a computer program product, wherein the computer program product may be stored in a non-transitory computer-readable medium and may include one or more instructions to cause the processor to perform specific operations. The non-transitory computer-readable medium may be, for example, a memory device, such as a memory, a hard disk, a flash drive or a cloud hard drive, but it is not limited thereto. In one embodiment, the processor and the memory device may be disposed in a computer electronic device, such as but not limited to a desktop computer, a notebook computer, a smart mobile device, a server or a cloud host. In addition, the change point detection unit 10, the data set segmentation unit 20, the feature value calculation unit 30 and the data type classification unit 40 may be implemented by the same or different processors, and may be disposed on the same or different computer electronic devices.

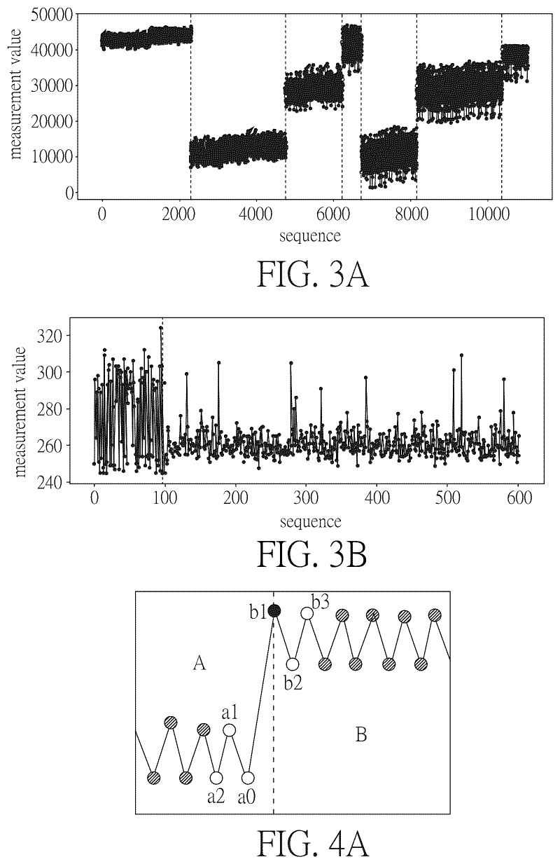

In order to make the purpose of the present disclosure easier to understand, the data type of the data set will be described. FIG. 3A is a schematic diagram of a data set according to an embodiment of the present disclosure, FIG. 3B is a schematic diagram of a data set according to another embodiment of the present disclosure, and please refer to FIG. 1 and FIG. 2 at the same time. In addition, in the charts shown in FIG. 3A and FIG. 3B, the horizontal axis represents the sequences of data values in the data set, and the vertical axis represents the measurement values of the data values.

As shown in FIG. 3A, within a period of time, the data set has a plurality of data values, and may be segmented into a plurality of regions. The number of measurement values of the data values (the sequence is approximately between 0 and 2000) in the first region is approximately between 40,000 and 50,000, and the number of measurement values of the data values in the second region (the sequence of each data value is approximately between 2,000 and 4,500) is approximately between 5,000 and 15,000. The average value of data values in the first region is significantly different from the average value of data values in the second region, so that it may be regarded as a change in the average value between the first region and the second region. Therefore, there is a data value change point existed between the first region and the second region. By analogy, it can be seen that the data set in FIG. 3A has changed six times during this period, and thus there are six data value change points.

As shown in FIG. 3B, within a period of time, the data set may be segmented into a plurality of regions. The number of measurement values of the data values (the sequence is approximately between 0 and 100) in the first region is approximately between 240 and 320, the number of measurement values of the data values (the sequence is over 100) in the second region is approximately between 240 and 280, the standard deviation of the data values in the first region is significantly different from the standard deviation of the data values in the second region, so that it may also be regarded as a change in the standard deviation of the first region and the second region, and thus there is a data value change point between the two regions. By analogy, the data set in FIG. 3B has changed one time in total during this period, and thus has one data value change point.

Due to changes in data values, the data sets in the embodiments of FIG. 3A and FIG. 3B cannot be controlled through typical methods. The embodiment in FIG. 3A is similar to a quasi-normal data type in which the average value changes, which is not suitable for using the same average value as a control standard, and the embodiment in FIG. 3B is similar to a unilateral data type in which the standard deviation changes, which is not suitable for using the same standard deviation value as the standard for control, so that the two embodiments need to be controlled through corresponding control methods. In one embodiment, in actual use, the data type of the data set may include, for example, data with an approximately normal distribution (hereinafter referred to as a quasi-normal data set model), data highly concentrated around the central value (hereinafter referred to as a highly narrow peak data set model), data asymmetrically distributed on both sides of the central value (hereinafter referred to as the unilateral data set model), values of the data set gradually increasing or decreasing over time (hereinafter referred to as the trend data set model) or other data types, but it is not limited thereto. It can be seen from this that, for the purpose of process automation, it is necessary to find the data value change points in the data set and determine the data type of the data set (that is, the data set model) for performing appropriate control.

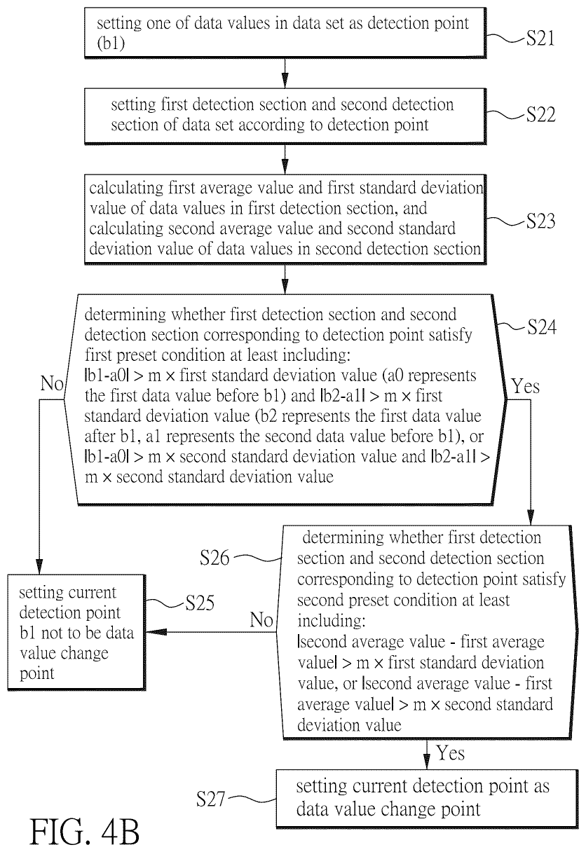

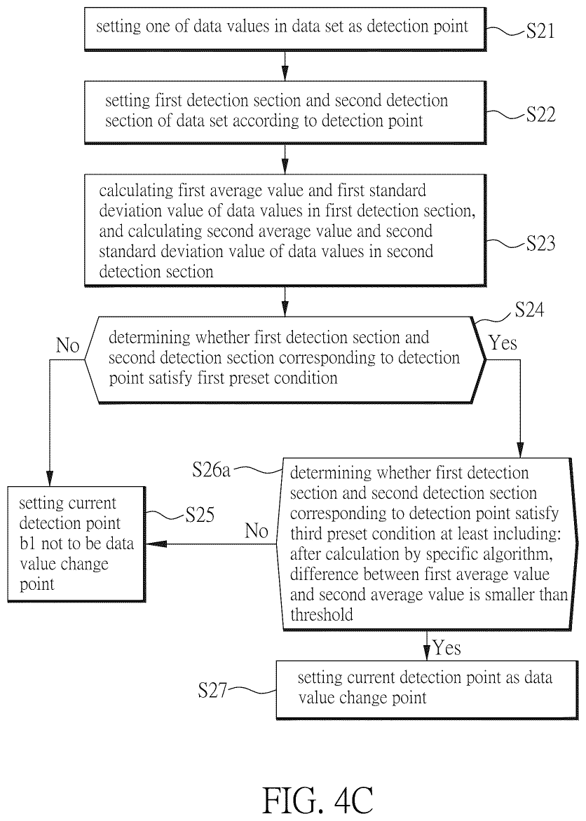

Next, the details of the system management method in FIG. 1 will be described. The following description will start directly from the data value change point detection procedure of step S2. FIG. 4A shows a schematic diagram of the data set corresponding to the data value change point detection procedure in the first aspect of the present disclosure, FIG. 4B shows a flowchart illustrating the steps of the data value change point detection procedure in the first aspect of the present disclosure, and please also refer to FIG. 1 to FIG. 3B.

As shown in FIG. 4A, by performing the data value change point detection process, the change point detection unit 10 may detect whether one of the data values in the data set is a data value change point. The one of the currently detected data values (hereinafter referred to as the detection point) is denoted by the symbol b1, and the data value of the first sequence before the detection point b1 is denoted by the symbol a0 (for convenience of explanation, “data value of which sequence” is referred to as “which data value”; specifically, data value of sequence i is referred to as i-th data value where i=1, 2, 3, . . . ). The second data value before the detection point b1 is denoted by the symbol a1, and the third data value before the detection point b1 is denoted by the symbol a2. The first data value after the detection point b1 is denoted by the symbol b2, and the second data value after the detection point b1 is denoted by the symbol b3. In the process of determining whether the detection point b1 is a data value change point, at least part of the data values a0˜a3 and b1˜b3 may be used as a basis for determination, but it is not limited thereto. In addition, FIG. 4A shows the situation where the average value of the data set changes.

The data value change point detection process (step S2) may be performed through the change point detection unit 10. As shown in FIG. 4B, step S21 is first executed to set one of the data values in the data set as a detection point b1. Then step S22 is executed to set a first detection section A and a second detection section B of the data set according to the detection point b1. Then, step S23 is executed to calculate the average value and standard deviation value of the data values in the first detection section A (hereinafter referred to as the first average value and the first standard deviation value), and to calculate the average value and standard deviation value of the data values in the second detection section B (hereinafter referred to as the second average value and the second standard deviation value). Then, step S24 is executed to determine whether the first detection section A and the second detection section B corresponding to the detection point b1 satisfy a first preset condition. When not satisfying the first preset condition, step S25 is executed to set the current detection point b1 not to be a data value change point. Then, step S21 may be executed again and a new detection point b1 may be set. When satisfying the first preset condition, step S26 is executed to determine whether the first detection section A and the second detection section B corresponding to the detection point b1 satisfy a second preset condition. When not satisfying the second preset condition, step S25 is executed to set the current detection point b1 not to be a data value change point, and then step S21 may be executed again to set a new detection point b1. When satisfying the second preset condition, step S27 is executed to set the current detection point b1 as the data value change point, and then step S21 is executed again to set a new detection point b1. The process is repeated to perform determination. Accordingly, when the first detection section A and the second detection section B corresponding to the detection point b1 satisfy both the first preset condition and the second preset condition, the detection point b1 may be determined and set to be the data value change point.

Regarding step S21, in one embodiment, when the data value change point detection procedure starts to be executed, the change point detection unit 10 is set to use the (N+1)-th data value in the data set as the first detection point b1 and, after completing the detection of the current detection point b1, the subsequent data values are detected sequentially, where N may be between 30 and 70 (30≤N≤70), such as 50, while it is not limited thereto. By using the (N+1)-th data value as the first detection point b1, it can be ensured that the amount of data of the first detection section A and the second detection section B is sufficient for analysis, while it is not limited thereto.

Regarding step S22, in one embodiment, the first detection section A may be set to include N data values before the detection point b1 (excluding the detection point b1), while it is not limited thereto. The second detection section B may be set to include the detection point b1 and N data values after the detection point b1 (a total of N+1 data values), or the second detection section B may be set to include the detection point b1 and N−1 data values after detection point b1 (a total of N data values), while it is not limited thereto.

Regarding step S23, in one embodiment, before calculating the first average value, the first standard deviation value, the second average value and the second standard deviation value, the change point detection unit 10 may first perform a data cleaning operation on the first section A and the second detection section B so as to remove, for example, outliers (noises) in the first detection section A and the second detection section B, thereby calculating first average value, first standard deviation value, second average value and second standard deviation value, with which the subsequent analysis may be more accurate. However, the data cleaning operation may be executed or not according to the needs.

Regarding step S24, in one embodiment, the first preset condition at least includes: the absolute value of the difference between the detection point b1 and the first data value a0 before the detection point b1 is greater than m times the first standard deviation value (|b1−a0|>m×first standard deviation value), and the absolute value of the difference between the first data value b2 after the detection point b1 and the second data value a1 before the detection point b1 is greater than m times the first standard deviation value (|b2−a1|>m×first standard deviation value), or the absolute value of the difference between the detection point b1 and the first data value a0 before the detection point b1 is greater than m times the second standard deviation value (|b1−a0|>m×second standard deviation value), and the absolute value of the difference between the first data value b2 after the detection point b1 and the second data value a1 before the detection point b1 is greater than m times the second standard deviation value (|b2−a1|>m×second standard deviation value), wherein m is a positive integer greater than 0. In addition, in one embodiment, m may be regarded as a difference parameter between the average changes of the first detection section A and the second detection section B. In one embodiment, m may be preset to 3, but may be adjusted according to the needs.

Furthermore, in one embodiment, in addition to the aforementioned content of (|b1−a0|>m×first standard deviation value, and |b2−a1|>m×first standard deviation value, or |b1−a0|>m×second standard deviation value, and |b2−a1|>m×second standard deviation value), the first preset condition may also include: the absolute value of the difference between the second data value b3 after the detection point b1 and the third data value a2 before the detection point b1 is greater than m times the first standard deviation value (|b3−a2|>m×first standard deviation value), or the absolute value of the difference between the second data value b3 after the detection point b1 and the third data value a2 before the detection point b1 is greater than m times the first standard deviation value (|b3−a2|>m×second standard deviation value), while it is not limited thereto. As a result, it is able improve the accuracy of determination without making the processing time too long. In addition, in other embodiments, the first preset condition may also include more content.

Regarding step S26, in one embodiment, the second preset condition at least includes: the absolute value of the difference between the second average value and the first average value is greater than m times the first standard deviation value (|second average value−first average value|>m×first standard deviation value), or the absolute value of the difference between the second average value and the first average value is greater than m times the second standard deviation value (|second average value−first average value|>m×second standard deviation value), while it is not limited thereto.

Regarding steps S25 and S27, after completing the detection of the current detection point b1, the change point detection unit 10 may execute steps S21 to S27 again for the new detection point. In one embodiment, the new detection point may be the first data value after the current detection point (for example, data value b2), while it is not limited thereto. In addition, regarding step S27, in one embodiment, after completing the detections of the first detection point to the last detection point, the change point detection unit 10 may find a plurality of data value change points in the data set.

As a result, the detection unit 100 may automatically determine whether there is a data value change point in the data set, and may find the data value change point.

FIG. 4C shows a flowchart illustrating the detection procedure of the data value change point in the first aspect of another embodiment of the present disclosure. The detection process of the data value change point in FIG. 4C may include steps S21 to S25, S26a and S27, wherein steps S21 to S25 and S27 are applicable to the description of the embodiment in FIG. 4B, and thus only step S26a will be described in the following.

When satisfying the first preset condition, step S26a may be executed to determine whether the first detection section A and the second detection section B corresponding to the detection point b1 satisfy a third preset condition.

In one embodiment, the third preset condition at least includes: after calculation by a specific algorithm, the difference between the first average value and the second average value is smaller than a threshold. In one embodiment, the specific algorithm is, for example, the Mann-Whitney double statistical population sample test, but it is not limited thereto. In one embodiment, the threshold may be between 0.01 and 0.1 (0.01≤threshold≤0.1), while it is not limited thereto. For example, assuming that the threshold is 0.05, and if the difference between the first average value and the second average value is smaller than 0.05, it indicates that there is a significant difference between the first average value and the second average value, so that the probability of the detection point being a data value change point is high. Therefore, when the first detection section A and the second detection section B corresponding to the current detection point b1 satisfy both the first preset condition and the third preset condition, the change point detection unit 10 may determine and set the current detection point b1 as the data value change point.

It is noted that the detection procedures of data value change points in FIG. 4B and FIG. 4C are suitable for detecting the state of the data set in which the data value change point belongs to the average value change, but it may still be used to detect other states.

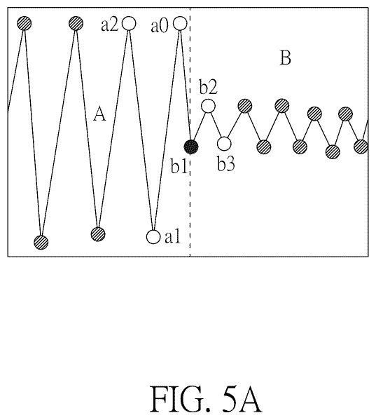

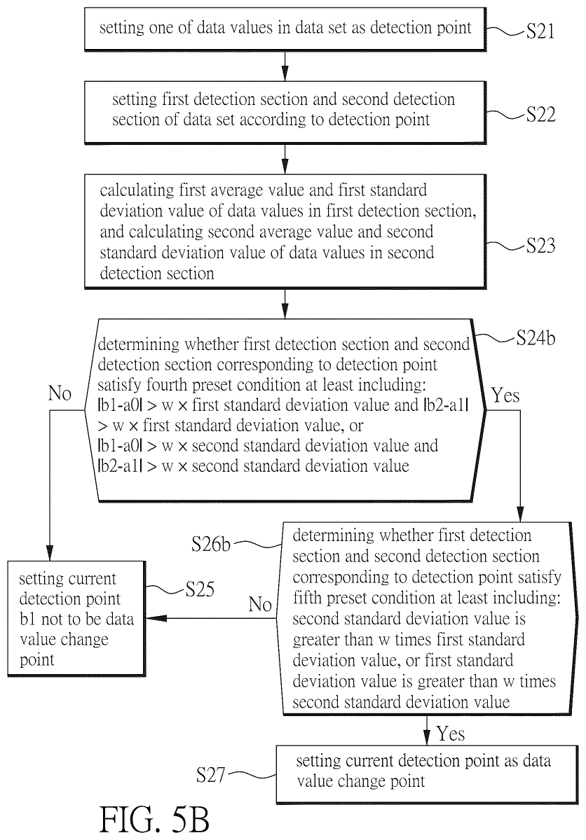

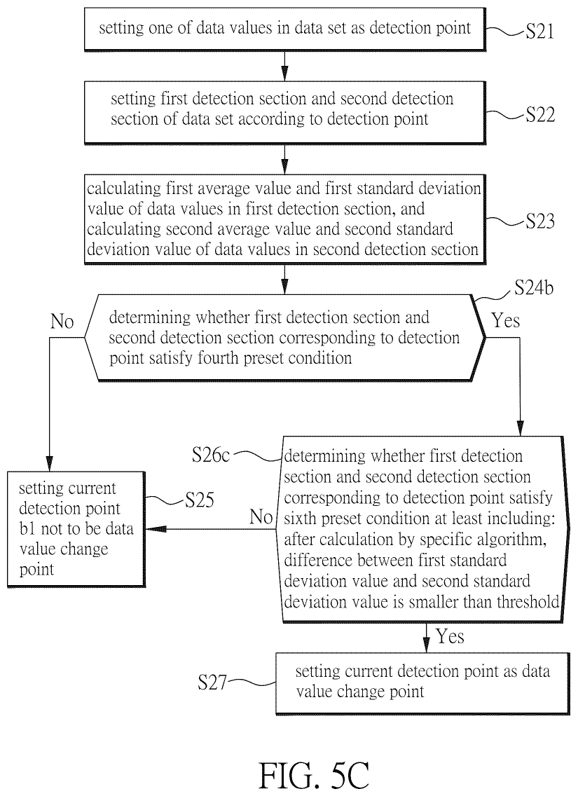

FIG. 5A shows a schematic diagram of the data set corresponding to the data value change point detection procedure in the second aspect of the present disclosure. FIG. 5B shows a flowchart illustrating the steps of the data value change point detection procedure in the second aspect of the present disclosure.

As shown in FIG. 5A, the current detection point of the data value change point detection procedure is denoted by symbol b1, the first data value before the detection point b1 is denoted by symbol a0, the second data value before the detection point b1 is denoted by symbol a1, the third data value before the detection point b1 is denoted by symbol a2, the first data value after the detection point b1 is denoted by symbol b2, and the second data value after the detection point b1 is denoted by symbol b3. The aforementioned detection point b1 and the data values a0˜a3 before the detection point b1 and the data values b2˜b3 after the detection point b1 may be used in the data value change point detection procedure. In addition, FIG. 5A shows the situation where the standard deviation value of the data set changes.

In the embodiment of FIG. 5B, the data value change point detection procedure may include steps S21 to S23, S24b, S25, S26b and S27, wherein the steps S21 to S23, S25 and S27 may be applicable to the description of the embodiment of FIG. 4B, and thus the following description mainly focuses on steps S24b and S26b.

After step S23 is executed, step S24b may be executed to determine whether the first detection section A and the second detection section B corresponding to the detection point b1 satisfy a fourth preset condition. When not satisfying the fourth preset condition, step S25 may be executed. When satisfying the fourth preset condition, step S26b may be executed to determine whether the first detection section A and the second detection section B corresponding to the detection point b1 satisfy a fifth preset condition.

Regarding step S24b, in one embodiment, the fourth preset condition at least includes: the absolute value of the difference between the detection point b1 and the first data value a0 before the detection point b1 is greater than w times the first standard deviation value (|b1−a0|>w×first standard deviation value), and the absolute value of the difference between the first data value b2 after the detection point b1 and the second data value a1 before the detection point b1 is greater than w times the first standard deviation value (|b2−a1|>w×first standard deviation value), or the absolute value of the difference between the detection point b1 and the first data value a0 before the detection point b1 is greater than w times the second standard deviation value (|b1−a0|>w×second standard deviation value), and the absolute value of the difference between the first data value b2 after the detection point b1 and the second data value a1 before the detection point b1 is greater than w times the second standard deviation value (|b2−a1|>w×second standard deviation value), where w is a positive integer greater than 0. In addition, in one embodiment, w may be regarded as the difference parameter of the standard deviation change of the first detection section A and the second detection section B. In one embodiment, w may be preset to 3, but may be adjusted according to the needs. In addition, in one embodiment, w and m are not necessarily the same.

Furthermore, in one embodiment, in addition to the aforementioned content (b1−a0|>w×first standard deviation value, and |b2−a1|>w×first standard deviation value, or |b1−a0|>w×second standard deviation value, and |b2−a1|>w×second standard deviation value), the fourth preset condition may also include: the absolute value of the difference between the second data value b3 after the detection point b1 and the third data value a2 before the detection point b1 is greater than w times the first standard deviation value (|b3−a2|>w×first standard deviation value), or the absolute value of the difference between the second data value b3 after the detection point b1 and the third data value a2 before the detection point b1 is greater than w times the first standard deviation value (|b3−a2|>w×second standard deviation value), while it is not limited thereto. As a result, it is able to improve the accuracy of determination without making the processing time too long. In addition, in other embodiments, the fourth preset condition may also include more content.

Regarding step S26b, in one embodiment, the fifth preset condition at least includes: the second standard deviation value is greater than w times the first standard deviation value, or the first standard deviation value is greater than w times the second standard deviation value. When the first detection section A and the second detection section B corresponding to the current detection point b1 satisfy both the fourth preset condition and the fifth preset condition, the current detection point b1 may be determined and set as the data value change point.

FIG. 5C shows a flowchart illustrating the steps of the data value change point detection procedure in the second aspect according to another embodiment of the present disclosure. In the embodiment of FIG. 5C, the data value change point detection procedure may include steps S21 to S23, S24b, S25, S26c and S27, wherein steps S21 to S23, S24b, S25 and S27 are applicable to the description of the embodiment in FIG. 5B, and thus only step S26c will be described in the following.

When satisfying the first preset condition, step S26c may be executed to determine whether the first detection section A and the second detection section B corresponding to the detection point b1 satisfy a sixth preset condition.

In one embodiment, the sixth preset condition at least includes: after calculation by a specific algorithm, the difference between the first standard deviation value and the second standard deviation value is smaller than the threshold (|first standard deviation value−second standard deviation values|<threshold). In one embodiment, the specific algorithm is, for example, the Mann-Whitney double statistical population sample test, but it is not limited thereto. In one embodiment, the threshold may be between 0.01 and 0.1 (0.01≤threshold≤0.1), but it is not limited thereto. For example, assuming that the threshold is 0.05, and if the difference between the first standard deviation value and the second standard deviation value is smaller than 0.05, it indicates that there is a significant difference between the first standard deviation value and the second standard deviation value, and thus the probability of the detection point being a data value change point is high. Therefore, when the first detection section A and the second detection section B corresponding to the current detection point b1 satisfy the fifth preset condition and the sixth preset condition at the same time, the current detection point b1 may be determined and set as the data value change point.

The data value change point detection procedure in the embodiment of FIG. 5B and FIG. 5C is suitable for detecting the state of the data set in which the data value change point belongs to the average value change, but it may still be used to detect other types of data value change point.

Accordingly, the detection procedure of the data value change point (step S2) can be understood.

Next, step S3 in FIG. 1 will be described. In one embodiment, when the data set has a plurality of data value change points, the data set segmentation unit 20 may segment the data set into a plurality of sections according to the plurality of data value change points. Taking the data set in FIG. 3A as an example, there are six data value change points, and thus the data set segmentation unit 20 may segment the data set into seven sections according to the data value change points. In addition, when the data set does not have a data value change point, the data set segmentation unit 20 may not operate.

Next, step S4 in FIG. 1 will be described. In one embodiment, when the data set is segmented into a plurality of sections, the feature value calculation unit 30 may compare the number of data values in each section, select the section with the largest number of data values, and then calculate the feature value of the section. It is noted that, in one embodiment, in step S2, the first detection point b1 is the (N+1)-th data value in the data set and, however, there may be undetected data value change points existed among the data values before the first detection point b1. In order to prevent the undetected data value change points from affecting the calculation of the feature value, the feature value calculation unit 30 may exclude the first N data values and/or the last N data values in the data set from the calculation of the feature value. For example, when the section selected by the feature value calculation unit 30 includes the first N data values and/or the last N data values in the data set, the feature value calculation unit 30 may delete the first N data values and/or the last N data values in the data set without using these data values to calculate the feature value, but it is not limited thereto.

In one embodiment, the feature value may include the slope, skewness, kurtosis or normal distribution value of the data values in the selected section, or any combination thereof, while it is not limited thereto. In one embodiment, the normal distribution value may be obtained through Jarque-Bera Test (J-B Test).

In one embodiment, when the feature value is a slope, it may be presented by the following formula:

$$slope = \overline{y} - \frac{{\sum }_{i = 1}^{n} [ ( {x}_{i} - \overline{x} ) ( {y}_{i} - \overline{y} ) ]}{{\sum }_{i = 1}^{n} {( {x}_{i} - \overline{x} )}^{2}} ,$$

where xi is the order of the data values in the selected section (starting from 1 to n), yi is the numerical value of the data value corresponding to xi in the selected section, and n is the number of data values in the selected section, x(bar) is the average value of xi, and y(bar) is the average value of yi.

In one embodiment, when the feature value is a skewness, it may be presented by the following formula:

$$skewness = \frac{\frac{1}{n} {\sum }_{i = 1}^{n} {( {y}_{i} - \overline{y} )}^{3}}{{( \frac{1}{n} {\sum }_{i = 1}^{n} {( {y}_{i} - \overline{y} )}^{2} )}^{\frac{4}{2}}} .$$

In one embodiment, when the feature value is a kurtosis, it may be presented by the following formula:

$$kurtosis = \frac{\frac{1}{n} {\sum }_{i = 1}^{n} {( {y}_{i} - \overline{y} )}^{4}}{{( \frac{1}{n} {\sum }_{i = 1}^{n} {( {y}_{i} - \overline{y} )}^{2} )}^{\frac{4}{2}}} .$$

In one embodiment, when the feature value is a normal distribution value, it may be presented by the following formula (Jarque-Bera test):

$$normal distribution value = \frac{{S}^{2}}{\frac{6}{n}} + \frac{{( K - 3 )}^{2}}{\frac{24}{n}} ,$$

where S is the skewness and K is the kurtosis.

As a result, the feature value calculation unit 30 may calculate the feature value of the selected section, and use the feature value as a feature value of the data set to be determined for subsequent processing.

Next, step S5 will be described. In one embodiment, when there is no data value change point existed in the data set, the feature value calculation unit 30 may calculate the feature value of all data values in the data set, while it is not limited thereto.

Next, step S6 will be described. In one embodiment, after the feature value calculation unit 30 calculates the feature values of a data set, the feature values of the data set may be input to the trained machine learning model 41 of the data type classification unit 40. The machine learning model 41 may analyze the feature values of the data set and define the data type of the data set. However, in order to enable the machine learning model 41 to have the aforementioned analysis capabilities, the machine learning model 41 must first be trained with a large amount of training data. Next, the training process of the machine learning model 41 will be described.

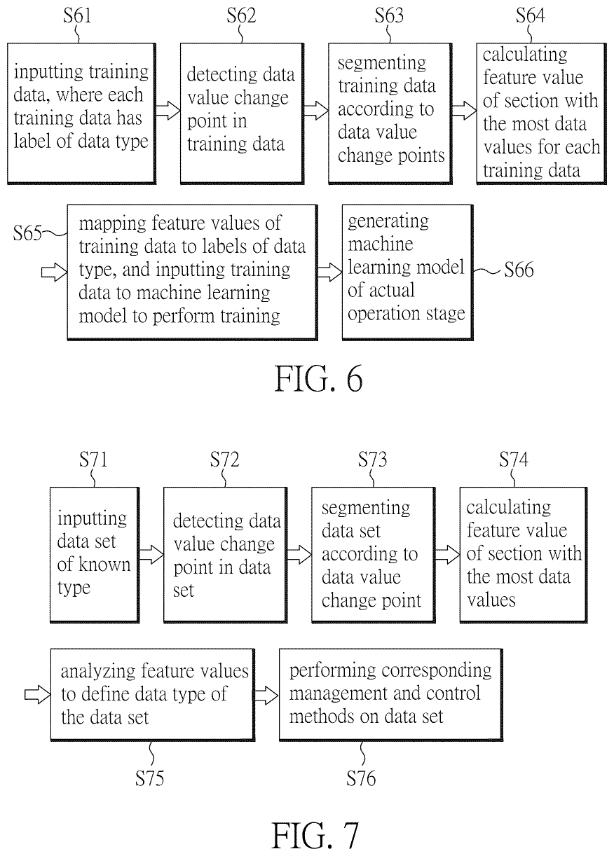

FIG. 6 shows a flowchart illustrating the training process of the data type classification unit 40 according to an embodiment of the present disclosure, and please refer to FIG. 1 to FIG. 5C at the same time, wherein steps S61 to S64 may be regarded as preprocessing steps and may be executed by components other than the data type classification unit 40, and steps S65 and S66 are executed by the data type classification unit 40.

As shown in FIG. 6, step S61 is first executed, in which a large amount of training data is input into the detection unit 100. Each training data may represent a data set, and each training data has a label, wherein the label is marked with a data type (i.e., data set model) of each training data. In one embodiment, the data type of each training data may be marked manually, but it is not limited thereto.

Then, step S62 is executed, in which the change point detection unit 10 may detect the data value change point in the training data. This step is similar to step S2 in FIG. 1, and thus a detailed description is deemed unnecessary.

Then, step S63 is executed, in which the data set segmentation unit 20 may segment the training data into sections according to the data value change points of the training data. This step is similar to step S3 in FIG. 1, and thus a detailed description is deemed unnecessary.

Then, step S64 is executed, in which, for each training data, the feature value calculation unit 30 may select the section with the most data values for calculation so as to calculate one or more feature values of each training data. In addition, if a training data does not have data value change points, the feature value calculation unit 30 will directly calculate one or more feature values of all data values of the training data. This step is similar to step S4 or S5 in FIG. 1, and thus a detailed description is deemed unnecessary.

Then, step S65 is executed, in which the detection unit 100 may map the feature values of the training data to the labels of the training data (for example, through instructions input by the user or according to preset instructions), and input the training data corresponding to the labels to the machine learning model 41 in the training stage for allowing the machine learning model 41 to perform training.

Then, step S66 is executed, in which, after the training of the machine learning model 41 is completed, the machine learning model 41 may be provided with the ability to analyze the feature values of the data set, and the actual operation stage is entered. After that, the unknown data set and its feature values may be input into the machine learning model 41 of the data type classification unit 40, and the machine learning model 41 of the data type classification unit 40 may automatically define the data type (i.e., data set model) of the unknown data set.

Next, the process of the actual operation stage of the machine learning model 41 of the data type classification unit 40 will be described. FIG. 7 shows a flowchart schematically illustrating the actual operation of the change point detection unit 10, the data set segmentation unit 20, the feature value calculation unit 30 and the data type classification unit 40 according to an embodiment of the present disclosure, and please refer to FIG. 1 to FIG. 6 at the same time.

As shown in FIG. 7, step S71 is first executed, in which a data set of known type is input into the detection unit 100.

Then, step S72 is executed, in which the change point detection unit 10 may detect the data value change point in the data set of known type. This step is similar to step S2 in FIG. 1.

Then, step S73 is executed, in which the data set segmentation unit 20 may segment the data set of known type into sections according to the data value change point. This step is similar to step S3 in FIG. 1.

Then, step S74 is executed, in which the feature value calculation unit 30 may select the section with the most data values for calculation so as to calculate one or more feature values of the data set of known type. In addition, if the data set of unknown type does not have a data value change point, the feature value calculation unit 30 directly calculates one or more feature values of all data values of the data set of unknown type. This step is similar to step S4 or step S5 in FIG. 1.

Then, step S75 is executed, in which the detection unit 100 (for example, the data type classification unit 40) may analyze the feature values found in step S74 so as to define the data type (i.e., data set model) of the data set of known type.

Then, step S76 is executed, in which the manufacturing apparatus 300 may receive the data type (i.e., the data set model) of the data set, thereby performing corresponding management and control methods on the data set accordingly.

Accordingly, the actual operation stage of the machine learning model 41 can be understood.

From the above description, it can be seen that the system management method executed by the detection system of the present disclosure may automatically detect the data value change point of the data set, and automatically analyze the data type of the data set, so as to significantly reduce manpower cost or time cost, or improve the accuracy of analysis, or improve the management efficiency.

In one embodiment, the present disclosure may determine whether a product in contention falls within the protection scope of the present disclosure at least by the operating modes of the product in contention, or by the algorithm of the product in contention to determine whether it falls within the protection scope of the present disclosure, while it is not limited thereto. In one embodiment, the algorithm of the product in contention may be obtained, for example, through reverse engineering, while it is not limited thereto.

The features among various embodiments of the present disclosure may be mixed and matched arbitrarily as long as they do not violate the spirit of the disclosure or conflict with each other.

The aforementioned specific embodiments should be construed as merely illustrative, and not limiting the rest of the present disclosure in any way.

1. A manufacturing system for an electronic device, comprising:
a manufacturing apparatus for providing a data set; and
a monitoring system for receiving the data set and calculating a feature value to define a data set model,
wherein the manufacturing apparatus receives the data set model to monitor a manufacturing process.

2. The manufacturing system as claimed in claim 1, wherein the data set includes a plurality of data values, and the monitoring system segments the data set into a first section and a second section based on a data value change point in the data values.

3. The manufacturing system as claimed in claim 2, wherein the first section includes a first number of data values, the second section includes a second number of data values, and the first number is greater than the second number.

4. The manufacturing system as claimed in claim 3, wherein the monitoring system calculates the data values of the first section to obtain the feature value.

5. The manufacturing system as claimed in claim 1, wherein the feature value includes a slope.

6. The manufacturing system as claimed in claim 1, wherein the feature value includes a skewness.

7. The manufacturing system as claimed in claim 1, wherein the feature value includes a kurtosis.

8. The manufacturing system as claimed in claim 1, wherein the feature value includes a normal distribution value.

9. The manufacturing system as claimed in claim 8, wherein the normal distribution value is obtained through a Jarque-Bera test.

10. The manufacturing system as claimed in claim 1, wherein the monitoring system further includes a detection unit for performing a data value change point detection procedure, and the data value change point detection procedure comprises the steps of:
setting one of the data values of the data set as a detection point;
setting a first detection section and a second detection section of the data set according to the detection point;
calculating a first average value and a first standard deviation value of the data values in the first detection section, and calculating a second average value and a second standard deviation value of the data values in the second detection section;
determining whether the first detection section and the second detection section corresponding to the detection point satisfy a first preset condition;
when satisfying the first preset condition, determining whether the first detection section and the second detection section corresponding to the detection point satisfy a second preset condition; and
when satisfying the second preset condition, setting the detection point as the data value change point.

11. The manufacturing system as claimed in claim 10, wherein the first preset condition includes: (|b1−a0|>m×the first standard deviation value) and (|b2−a1|>m×the first standard deviation value), or (|b1−a0|>m×the second standard deviation value) and (|b2−a1|>m×the second standard deviation value), where b1 represents the detection point, a0 represents the first data value before the detection point, b2 represents the first data value after the detection point, a1 represents the second data value before the detection point, and m is a positive integer greater than 0.

12. The manufacturing system as claimed in claim 10, wherein the first preset condition includes: (|b1−a0|>m×the first standard deviation value) and (|b2−a1|>m×the first standard deviation value) and (|b3−a2|>m×the first standard deviation value), or (|b1−a0|>m×the second standard deviation value) and (|b2−a1|>m×the second standard deviation value) and (|b3−a2|>m×the second standard deviation value), where b1 represents the detection point, a0 represents the first data value before the detection point, b2 represents the first data value after the detection point, a1 represents the second data value before the detection point, b3 represents the second data value after the detection point, a2 represents the third data value before the detection point, and m is a positive integer greater than 0.

13. The manufacturing system as claimed in claim 11, wherein the second preset condition includes: (|the second average value−the first average value|>m×the first standard deviation value), or (|the second average value−the first average value|>m×the second standard deviation value).

14. The manufacturing system as claimed in claim 11, wherein the third preset condition includes: using an algorithm to calculate that a difference between the first average value and the second average value is smaller than a threshold.

15. The manufacturing system as claimed in claim 14, wherein the algorithm is a Mann-Whitney double statistical population sample test, and the threshold is between 0.01 and 0.1.

16. The manufacturing system as claimed in claim 10, wherein the first preset condition includes: (|b1−a0|>w×first standard deviation value) and (|b2−a1|>w×first standard deviation value), or (|b1−a0|>w×second standard deviation value) and (|b2−a1|>w×second standard deviation value), where b1 represents the detection point, a0 represents the first data value before the detection point, b2 represents the first data value after the detection point, a1 represents the second data value before the detection point, and w is a positive integer greater than 0.

17. The manufacturing system as claimed in claim 16, wherein the first preset condition includes: (|b1−a0|>w×first standard deviation value) and (|b2−a1|>w×first standard deviation value) and (|b3−a2|>w×first standard deviation value), or (|b1−a0|>w×second standard deviation value) and (|b2−a1|>w×second standard deviation value) and (|b3−a2|>w×second standard deviation value), where b1 represents the detection point, a0 represents the first data value before the detection point, b2 represents the first data value after the detection point, a1 represents the second data value before the detection point, b3 represents the second data value after the detection point, a2 represents the third data value before the detection point, and w is a positive integer greater than 0.

18. The manufacturing system as claimed in claim 16, wherein the second preset condition includes: the second standard deviation value is greater than w times the first standard deviation value, or the first standard deviation value is greater than w times the second standard deviation value.

19. The manufacturing system as claimed in claim 16, wherein the second preset condition includes: using an algorithm to calculate that a difference between the first standard deviation value and the second standard deviation value is smaller than a threshold.

20. The manufacturing system as claimed in claim 19, wherein the algorithm is a Mann-Whitney double statistical population sample test, and the threshold is between 0.01 and 0.1.
